(19) United States
(12) Patent Application Publication
(10) Pub. No.: US 2025/0390708 A1
(43) Pub. Date: Dec. 25, 2025

(54) FUNCTION CALLING

(71) Applicant: Intuit Inc., Mountain View, CA (US)

(72) Inventors: Dusan Bosnjakovic, Los Angeles, CA (US); Prarit Lamba, San Diego, CA (US); Shivakumara Narayanaswamy, Mountain View, CA (US); Neo Yuchen, Arcadia, CA (US); Anmol Joshi, San Diego, CA (US)

(73) Assignee: Intuit Inc., Mountain View, CA (US)

(21) Appl. No.: 18/751,151

(22) Filed: Jun. 21, 2024

(51) Int. Cl. G06N 3/045; G06N 3/0475; G06N 3/08

(52) U.S. Cl. CPC G06N 3/045; G06N 3/0475; G06N 3/08

(57) ABSTRACT

Implementations of the subject matter described in this disclosure may be used to process queries received from a user of an online resource and route the received queries to various agents that are determined to be the most suitable for performing one or more functions in response the user queries. For each of one or more received queries, an example method may determine a function corresponding to the one or more queries, select, for each function, at least one agent of a plurality of agents based on the one or more queries, send the one or more queries to a respective agent of the selected one or more agents, and receive, from a responding agent of the selected at least one agent, at least one of a document, a message, or a link representing a result of performing the function.

### TECHNICAL FIELD

This disclosure relates generally to generative artificial intelligence (AI) models, such as large language models (LLMs), and more specifically to the processing of multi-part user questions or queries using generative artificial intelligence (AI) models for executing functions in response to such questions or prompts.

### DESCRIPTION OF RELATED ART

Automated assistants can be used to provide users with product and/or service assistance in a cost-effective manner. In many cases, automated assistants may employ multiple large language models (LLMs) that can be trained to generate responses to different user questions or queries. One popular LLM is ChatGPT® from OpenAIR. The ChatGPT model receives a user input requesting a text output from the model and generates text output based on the user input. While ChatGPT is one example LLM, various other LLMs can be used including, for example, InstructGPT, GPT-4, Google® Bard, and so on. Due to differing configurations and training processes, LLMs can have specialized functions. For example, a particular LLM may be considerably better at answering some types of user questions than other types of user questions, and one LLM may be considerably better at answering some types of user questions than another LLM. As such, an automated assistant may use a variety of different LLMs for answering different types of questions from various users.

Users may also request an automated assistant to perform one or more specified actions. For example, a user may request that the automated assistant gather information, and then generate a document, such as a report or email, to fill in a form, and so on. Because the types of information that may be gathered may be different and/or may be structured differently depending on the type of information, an LLM or other generative AI model specialized to the type of information requested may be considerably better at gathering the requested type of information than another generative AI model. Similarly, a generative AI model specialized to the generation of a particular type of document, or to the performance of certain types of actions may be considerably better at these tasks than a generic generative AI model (or generative AI model specialized to the performance of different types of actions).

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter described in this disclosure can be implemented as a method for assisting a user of an online resource. The method includes receiving, from the user over a communications network coupled to the computing system, a query including a plurality of sub-queries. The method includes determining a function corresponding to each of the sub-queries, and selecting, for each function, one agent of a plurality of agents based on a context for the corresponding sub-query. The method includes sending each sub-query to a corresponding selected agent and receiving, from each of the selected agents, at least one of a document, a message, or a link representing a result of performing the corresponding function. In various aspects, each of the plurality of agents is associated with a corresponding large language model (LLM) trained using query-and-response training data associated with a unique context or a unique group of contexts.

In some instances, the function includes gathering information and generating the document based at least in part on the gathered information. The document may include at least one of a report generated using the gathered information, a form including one or more fields completed based on the gathered information, or an email generated based on the gathered information.

Selecting the agent for a respective function may include selecting an ordered plurality of agents for performing the respective function. In some instances, the ordered plurality of agents includes a first agent configured to gather information and a second agent configured to perform one or more actions based at least in part on the information gathered by the first agent. In some aspects, the first agent is configured to return the gathered information via the communications network to the computing system, and the method further includes sending at least a portion of the gathered information via the communications network to the second agent.

The query may be received during a conversation between the user and an automated assistant associated with the online resource, and the context for each sub-query is based at least in part on one or more previous portions of the conversation. In some aspects, the context for each sub-query further includes a browsing history of the user within a user assistance page or web site associated with the online resource. In other aspects, the context for each sub-query is further based on a type of application through which the user accesses the online resource.

Another innovative aspect of the subject matter described in this disclosure can be implemented as a computing system associated with an online resource. The computing system includes one or more processors and a memory communicatively coupled with the one or more processors. The memory stores instructions that, when executed by the one or more processors, causes the computing system to receive, from the user over a communications network coupled to the computing system, a query including a plurality of sub-queries. Execution of the instructions causes the computing system to determine a function corresponding to each of the sub-queries, and to select, for each function, one agent of a plurality of agents based on a context for the corresponding sub-query. Execution of the instructions causes the computing system to send each sub-query to a corresponding selected agent and to receive, from each of the selected agents, at least one of a document, a message, or a link representing a result of performing the corresponding function. In various aspects, each of the plurality of agents is associated with a corresponding LLM trained using query-and-response training data associated with a unique context or a unique group of contexts.

In some instances, the function includes gathering information and generating the document based at least in part on the gathered information. The document may include at least one of a report generated using the gathered information, a form including one or more fields completed based at least in part on the gathered information, or an email generated based on the gathered information.

Execution of the instructions further causes the computing system to select the agent for the function may include selecting an ordered plurality of agents for performing the function. In some instances, the ordered plurality of agents includes a first agent configured to gather information and a second agent configured to perform one or more actions based at least in part on the information gathered by the first agent. In some aspects, the first agent is configured to return the gathered information via the communications network to the computing system, and execution of the instructions further causes the computing system to send at least a portion of the gathered information via the communications network to the second agent.

The query may be received during a conversation between the user and an automated assistant associated with the online resource, and the context for each sub-query is based at least in part on one or more previous portions of the conversation. In some aspects, the context for each sub-query further includes a browsing history of the user within a user assistance page or web site associated with the online resource. In other aspects, the context for each sub-query is further based on a type of application through which the user accesses the online resource

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example network environment associated with an online resource, according to some implementations.

FIG. 2 shows an example process flow for routing user requests from an automated assistant associated with an online resource, according to some implementations.

FIG. 3 depicts an example process flow for performing a function in response to complex queries from a user, in accordance with some implementations.

FIG. 4 shows an example process flow through which an example query is decomposed, augmented, and answered, according to some implementations.

FIG. 5 shows an illustrative flowchart depicting an example operation for performing functions in response to a query provided by the user of the online resource, according to some implementations.

Like reference numbers and designations in the various drawings indicate like elements.

### DETAILED DESCRIPTION

Implementations of the subject matter described in this disclosure may be used to receive a query from a user of an online resource, decompose the query into a plurality of sub-queries, and select, for each sub-query, one of a plurality of agents to perform one or more functions associated with the sub-query. Each agent is associated with a large language model (LLM) that can be configured to generate responses for queries having a unique context or group of contexts, to perform one or more functions responsive to a respective sub-query, or both. In some aspects, each LLM can be trained using query-and-response function relationships associated with a respective function or group of functions. In various aspects, the functions may include generating a document or report responsive to a corresponding sub-query, completing one or more fields of a form responsive to the corresponding sub-query, or generating an email and sending the email to one or more indicated recipients in response to the corresponding sub-query. The contexts may include one or more previous portions of a conversation between the user and an automated assistant, a browsing history of the user within a user assistance page or site associated with the online resource, an application associated with the conversation, one or more pieces of user-specific information, and so on. The user-specific information may include demographic information associated with the user, account information associated with the user, financial information associated with the user, and so on.

In accordance with aspects of the present disclosure, the online resource can route the sub-queries decomposed from a user query to various agents that are each selected as the most suitable agent for performing the one or more functions responsive to a respective sub-query. The selection of agents most suitable for each function (or the selection of multiple agents for performing a single complex function) may not only reduce latencies associated with performing the functions but may also increase the likelihood that the functions are accurately performed and based on the most recently available information (e.g., as compared with using the same or similarly-configured agent to perform all of the functions). For example, a first agent and its associated LLM can be configured to generate a document or report responsive to a corresponding sub-query, a second agent and its associated LLM can be configured to complete one or more fields of a form responsive to the corresponding sub-query, and a third agent and its associated LLM can be configured to generate and send an email to one or more indicated recipients in response to the corresponding sub-query, among other examples. In this way, the online resource ensures that each of the sub-queries is routed to an agent that has been configured and trained to perform one or more corresponding functions having the same or similar context.

Aspects of the subject matter disclosed herein are not an abstract idea such as a mental process that can be performed in the human mind, for example, because the human mind is not capable of implementing an online resource that is accessible by users over one or more communications networks (e.g., the Internet). Nor is the human mind capable of transmitting queries to an online resource or receiving queries from another electronic device over one or more communications networks. Indeed, the human mind is neither equipped to nor capable of transmitting or receiving anything over a communications network—let alone transmitting or receiving queries to or from an automated assistant associated with an online resource over any communications network. Further, the human mind is not capable of implementing any generative AI models, and so for example the human mind is not capable of implementing a large language model or LLM, much less using such an LLM for processing queries, altering such queries based on various contexts, or selecting a most appropriate agent from a plurality of agents which is most appropriate for performing a function in response to a given query or queries. Lastly, the human mind is not capable of sending any queries from an online resource to a selected agent, nor of receiving a result of a function performed by the selected agent or agents. Aspects of the subject matter disclosed herein are not an abstract idea such as a method of organizing human activity because the claims of this patent application do not recite any fundamental economic practice, commercial interaction, legal interaction, or business relations. Moreover, various aspects of the present disclosure provide a technical solution to a technical problem rooted in technology, namely, improving the capability of a computing device to automatically perform function in response to complex human language queries submitted by its users.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. As such, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

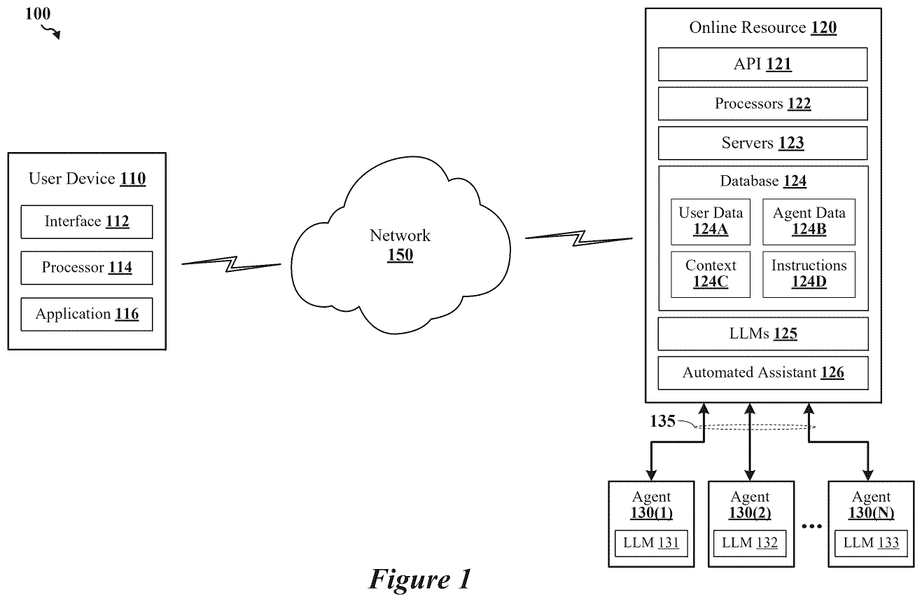

FIG. 1 shows an example network environment 100 associated with an online resource, according to some implementations. The network environment 100 is shown to include a user device 110, an online resource 120, a plurality of agents 130(1)-130(N), and a communications network 150. The user device 110, which can be any suitable wired or wireless computing device that can access and communicate with the online resource 120 over the communications network 150, is associated with a registered user of the online resource 120. In some instances, the user device 110 can be a desktop computer, laptop computer, tablet computer, personal digital assistant, cellular telephone, smartphone, electronic book reader, or other suitable device capable of accessing and communicating with the online resource 120 over the communications network 150. Although only one user device 110 is shown in the example of FIG. 1 for simplicity, any number of other user devices can be used to connect other users to the online resource 120 over the communications network 150. In addition, although not shown for simplicity, the network environment 100 may include other computing devices, servers, interfaces, online resources, or third-party systems.

The user device 110 is shown to include an interface 112, a processor 114, and an application 116. The interface 112 can be used by the user to interact with the online resource 120 over the communications network 150. For example, the interface 112 allows the user to enter requests, queries, and other information that can be transmitted to the online resource 120 by one or more transceivers (not shown for simplicity) associated with the user device 110. The interface 112 also allows the user to view and interact with data, reports, content, messages, services, and other information provided by the online resource 120 and transmitted to the user device 110. In various aspects, the interface 112 may include a display screen, an audio interface, a virtual reality headset, an augmented reality headset, a digital assistant, a haptic interface, a motion-detection interface, a sensor interface, a keyboard, a trackpad, a trackball, and/or a mouse (among other examples) that can receive spoken queries and/or typed queries from the user, and present audible responses and/or graphical responses to such user queries. In some aspects, the interface 112 may include a specialized automated assistant interface that can facilitate a conversation between the user and an automated assistant associated with the online resource 120.

The processor 114 can be any suitable one or more processors capable of executing scripts or instructions of one or more software programs stored in memory associated with the user device 110. In some instances, the processor 114 can include or can be associated with a non-volatile memory that stores the scripts or instructions. In other instances, the processors 122 can be or can include an Application Specific Integrated Circuit (ASIC), one or more Field Programmable Gate Arrays (FPGAs), or one or more Programmable Logic Devices (PLDs).

The software application 116, which in some instances can be an “App” suitable for mobile devices, allows the user to access, communicate, and exchange information with the online resource 120 over the communications network 150. For example, when executed by the processor 114, the application 116 can allow the user to login to the online resource 120 and thereafter interact with content and services associated with the online resource 120. In addition, or in the alternative, the user device 110 may include a generic browser through which the user can access, communicate with, and exchange information with the online resource 120.

The online resource 120 may provide a broad range of products, applications, services, subscriptions, and the like to a plurality of users (for simplicity, the users are not shown in FIG. 1) that can register, communicate, and exchange information with the online resource 120 via user devices such as user device 110. In the example of FIG. 1, the online resource 120 is shown to include an application program interface (API) 121, one or more processors 122 and/or one or more servers 123, a database 124, one or more large language models (LLMs) 125, and an automated assistant 126. The API 121 can provide a programmatic interface that allows the user device 110 to communicate with the online resource 120 over the communications network 150. In some instances, the programmatic interface of the API 121 can allow the application 116 residing on the user device 110 to request invocation of the automated assistant 126, to receive one or more user queries from the user device 110, and to transmit responses to the one or more queries over the communications network 150 to the user device 110, among other examples. In other instances, the API 121 can implement a user portal through which a web browser associated with the user device 110 can access the online resource 120, request invocation of the automated assistant 126, send one or more user queries to the online resource 120, and receive responses to the one or more queries generated by the online resource 120, among other examples.

In various aspects, the API 121 can receive requests from the user device 110 as Hyper-Text Transfer Protocol (HTTP) requests, API requests, or other web-based requests and thereafter communicate with the user device 110 sing one or more Hyper Text Markup Language (HTML) files responsive to the request. In some instances, the API 121 may, in conjunction with an application logic layer (not shown for simplicity), generate the HTML files as web pages that can be transmitted to the user device 110 over the communications network 150. In some aspects, the user device 110 may present HTML files received from the online resource 120 as web pages to the user.

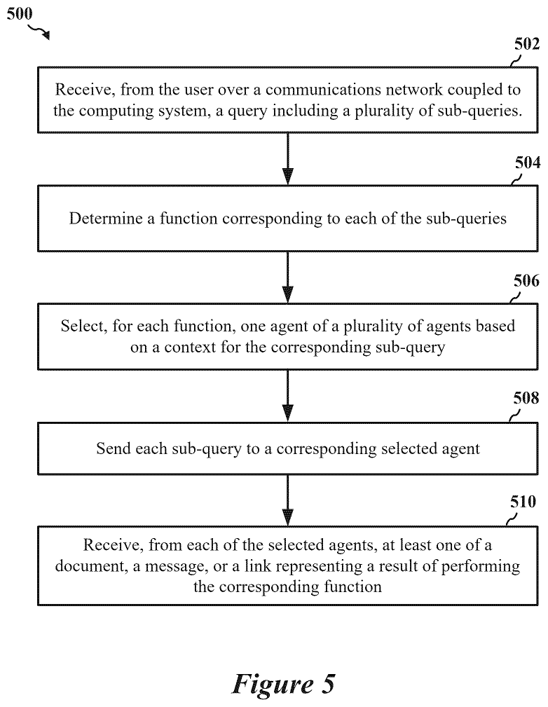

The processors 122 can be any suitable one or more processors capable of executing scripts or instructions of one or more software programs stored in memory associated with the database 124. In some aspects, the processors 122 can include one or more ASIC, FPGAs, or PLDs, among other examples. In accordance with aspects of the present disclosure, the processors 122 can execute instructions stored in the database 124 to perform various operations described herein with respect to the flow charts of FIGS. 5A and 5B.

The servers 123 may include various types of servers such as (but not limited to) a web server, a news server, a file server, an application server, a database server, a proxy server, or any other server suitable for performing functions or processes described herein. Each server 123 may be a unitary server or a distributed server spanning multiple computers or multiple datacenters, and may include hardware, software, or embedded logic components or a combination of two or more such components for carrying out the appropriate functionalities implemented or supported by the server 123. In some instances, each server 123 may include one or more processors (such as processors 122) capable of executing scripts or instructions of one or more software programs stored in an associated memory. In other instances, the servers 123 may be implemented using any suitable number of ASICs, FPGAs, or PLDs, among other examples.

The database 124 stores user data, product data, service data, and other information associated with the online resource 120. In some instances, the database 124 can be a relational database capable of manipulating various data sets using relational operators. The database 124 can also use Structured Query Language (SQL) for performing queries and database maintenance, and information stored in the database 124 can be arranged in tabular form, either collectively in a feature table or individually within each of the data sets. In the example of FIG. 1, the database 124 is shown to include a user data store 124A, an agent data store 124B, a context data store 124C, and instructions 124D.

The user data store 124A may store profile information for users registered with or otherwise associated with the online resource 120. The profile information for a respective user may include personal information and/or personal attributes including (but not limited to) name, age, birthday, gender, current residence, hometown, birthplace, educational history, work history, current or former employers, spousal information, children information, among other examples. In various aspects, the user data store 124A may also store documents, files, and other information associated with one or more user accounts provided by the online resource 120. For example, in some aspects, a respective user may have an accounting software service or subscription provided by the online resource 120, a tax preparation software service or subscription provided by the online resource 120, a banking account provided by the online resource 120, and/or a mortgage account provided by the online resource 120, among other examples.

The agent data store 124B may store configuration information, training data, agent descriptions, function descriptions and/or other information for each of the plurality of agents 130(1)-130(N). The configuration information for a respective agent 130 may be used to configure its one or more associated generative AI models to generate responses, gather information, and/or perform actions in response to user queries involving one or more associated functions, and the training data for the respective agent 130 may be used to train the one or more associated generative AI models with query-and-response data tailored to products, services, and practices associated with one or more associated contexts. For example, the generative AI models associated with an agent 130 configured to generate responses to user queries involving tax-related matters can be trained with training data indicating query-and-response relationships that involve tax laws, regulations, and/or common practices. Relatedly, the generative AI models associated with an agent 130 configured to generate documents involving tax-related matters can be trained with training data including user demographic and financial information in association with completed tax forms including such user demographic and financial information.

For another example, the generative AI models associated with an agent 130 configured to generate responses to user queries involving accounting matters can be trained with training data indicating query-and-response relationships that involve established accounting principles, applicable accounting rules and regulations, and/or banking practices, among other examples. Relatedly, the generative AI models associated with an agent 130 configured to generate reports involving accounting matters can be trained with training data including user queries and user financial data and be associated with completed documents presenting such information. For yet another example, the generative AI models associated with an agent 130 configured to generate responses to user queries involving product or service questions (such as a help line or link for an online mortgage service) can be trained with training data indicating query-and-response relationships based on previous conversations or message exchanges during which a user's questions about how to perform certain operations provided by the online resource 120 (such as how to run a report, how to generate a graph indicative of certain data or trends, or how to access an account or service provided by the online resource 120) were successfully answered.

More generally, some types of generative AI models associated with agents 130(1)-130(N) may be configured to gather information in one or more of a variety of contexts, and may be trained with training data indicating raw data (such as user demographic data, financial data, account-related information, and so on) and corresponding structured relevant data. Other generative AI models associated with agents 130(1)-130(N) may be configured to receive structured data relevant to a specific function and to output a document or to perform one or more actions using the structured data, and may be trained with training data including the structured relevant data in addition to documents including such data or one or more results of performing the one or more actions using that structured data.

The agent descriptions may also describe or indicate one or more contexts associated with each of the plurality of agents 130(1)-130(N) which can be used to aid selection of one of the agents 130(1)-130(N) to perform one or more steps of a function in response to a query or a sub-query of a multi-part user query, to gather information for a multi-step function, or to perform an action based on data gathered by another agent as another part of such a multi-step function. In various aspects, the agent descriptions can indicate an assignment of one or more contexts to each of the plurality of agents 130(1)-130(N). The agent descriptions may also indicate a dependency associated with one or more of the agents 130(1)-130(N), such as an agent being configured to gather data for use by one or more other agents, or to receive data from one or more other agents and to perform an action, such as generating a document or running a script based on the received data.

The agent data store 124B may also store function descriptions associated with one or more of the plurality of agents 130(1)-130(N). Because performing a given function may often require the use of multiple agents, the received query or multiple sub-queries may be compared to one or more of the function descriptions in order to assign the query or sub-queries to a given function based on a similarity between the query or sub-queries and the function description of the given function. The function descriptions may also indicate a dependency between a function and one or more of the agents 130(1)-130(N), as multiple agents may be required for performing a single function. For example, a first agent may gather data, a second agent may process the gathered data, while a third agent may generate a document based on the processed data. Accordingly, in some aspects a function description may indicate an ordered plurality of agents required for performing the function. Thus, assigning a query, or assigning multiple sub-queries to a particular function may correspond to the selection of multiple agents, such as selection of such an ordered plurality of agents for performing that function.

The context data store 124C may store a plurality of contexts that can be associated with user queries and/or assigned to at least some of the agents 130(1)-130(N). Each context can include one or more content, topics, subject matters, key words, or attributes, among other examples. In some instances, some contexts can include one or more previous portions of the conversation between the user and the automated assistant. For example, if a user query includes multiple topics (e.g., how do I add an employee, how do I add a vendor, how do I run payroll, how much does my company owe in taxes, or how much did insurance cost per employee last year), the online resource 120 segments the user query into a plurality of sub-queries based on their respective contexts (e.g., different topics), and selects one of the agents 130(1)-130(N) for each of the segmented sub-queries to a selected agent 130 based on a comparison between the context of the sub-query and the agent description associated with identifies the context associated with each of the sub-queries we segment it into smaller portions that can be routed to corresponding search engines or agents-with each agent associated with a different QBO sub-system (e.g., taxes and labor). In other instances, some contexts can include a browsing history of the user within a user assistance web page or other websites associated with the online resource 120. Further, a group of queries may represent a request for an action to be performed based on data which is to be gathered and the contexts may divide the function into a series of steps. Each step may be assigned to a different agent so that the function may be performed through one or more agents gathering the relevant data and a different one or more agents performing the requested action based on the gathered data.

The instructions 124D may include one or more sets of instructions, scripts, or machine-readable commands that can be executed by the processors 122 and/or the servers 123 to implement various functions and operations associated with the online resource 120. For example, execution of the instructions 124D can cause the online resource 120 to perform some or all of the operations described below with respect to the flow chart of FIG. 5.

The LLMs 125 may include one or more LLMs that are configured to generate responses to user queries or sub-queries in an accurate manner with minimal latencies. In various aspects, the LLMs 125 can be configured and trained to receive queries or sub-queries in a natural language format and to generate their respective responses in a natural language format. In some aspects, the LLMs 125 can be pretrained by the online resource 120. The LLMs 125 may be responsive to typed or entered queries or sub-queries, as well as spoken or verbal queries or sub-queries. In some instances, the LLMs 125 can form part of one or more generative AI models. For example, such generative AI models may be configured to generate one or more documents in response to provided information or data, to execute one or more scripts based on gathered data or configuration information, and so on. In addition, or in the alternative, the LLMs 125 can be associated with Natural Language Processors (NLPs). Further, although the LLMs 125 are shown in the example of Figure I as residing within the database 124 of the online resource 120, in other implementations, at least some of the LLMs 125 may reside in one or more corresponding agents 130(1)-130(N).

The automated assistant 126 can be used to assist the user navigate websites and pages provided by the online resource 120, to assist the user with obtaining answers to questions pertaining to the operations, functionalities, capabilities, and/or other aspects of one or more products or services associated with the online resource 120, and to assist the user with performing functions or generating documents based on data and other information associated with or accessible to one or more user accounts provided by the online resource 120, among other examples. In some instances, the automated assistant 126 can be invoked by the user uttering a designated word or phrase (e.g., “open the automated assistant”) into the user device 110, by the user touching an icon displayed on a mobile device, or by the user clicking a button or link presented on a monitor, among other examples. When invoked by the user, the automated assistant can initiate a conversation between the user and the automated assistant over the communications network 150. In some instances, the conversation may be conducted over an online chat or messaging feature accessible to the user. In other instances, the conversation may be conducted over a voice call with the user.

During the conversation, the automated assistant 126 can identify a plurality of queries spoken or input by user and determine a function corresponding to one or more of the identified queries based on a similarity between the one or more identified queries and a respective function description of the agent data 124B. For each of the functions, the automated assistant 126 can select at least one of the agents 130 to perform the function based on the one or more queries, as indicated in the respective function description, and then send the queries to one of the selected agents 130. The automated assistant 126 may receive at least one of a document, message, or a link representing a result of performing the function, and present the document, message, or link to the user via the user device 110.

The plurality of agents 130(1)-130(N) are shown in the example of FIG. 1 as being coupled to the online resource 120 via connection 135. In various aspects, the connection 135 may include one or more wireless connections (such as a Wi-Fi, LAN, WAN, MAN, cellular, or 5G network, among other examples) and/or one or more wired connections 135 (e.g., such as Ethernet cables or optical connections, among other examples. The agents 130(1)-130(N) can employ any suitable communication protocols to facilitate access and the exchange of data (such as receiving user queries and transmitting their respective responses) with the online resource 120. In some implementations, the online resource 120 and each of the agents 130(1)-130(N) may include a dedicated API through which the online resource 120 sends user queries to the selected agents 130 and the selected agents 130 send their respective responses to the online resource 120. In other implementations, the plurality of agents 130(1)-130(N) can be part of the online resource 120, in which case the connection 135 and dedicated APIs.

The agents 130(1)-130(N) can include (or can be otherwise associated with) large language models (LLMs) 131-133, respectively. The LLMs 131-133 can be any suitable large language model that can be used to generate responses to one or more portions of a user query. The LLMs 131-133 can be configured and/or trained to receive queries or sub-queries in a natural language format and to generate responses in a natural language format. For example, the LLMs 131-133 may be responsive to queries typed by the user, to queries entered by the user via a touch pad or touch screen, and/or to queries spoken by the user, among other examples. The LLMs 131-133 can form part of one or more generative AI models that can be trained to generate responses to complex or multi-part user queries. In other aspects, the LLMs 131-133 can be associated with one or more Natural Language Processors (NLPs). Further, although the LLMs 131-133 are shown in the example of FIG. 1 as residing within respective agents 130(1)-130(N), in other implementations, the LLMs 131-133 can be implemented using the LLMs 125 associated with the online resource 120.

The agents 130(1)-130(N) can be configured to generate responses to different user queries (or sub-queries), for example, such as queries pertaining to different contexts. In some instances, the LLMs 131-133 associated with respective agents 130(1)-130(N) can be trained using query-and-response training data associated with a unique context or a unique group of contexts. For example, a first agent 130(1) may be configured to generate responses for queries that involve accounting matters and its associated LLM 131 can be trained using query-and-response relationships pertaining to established accounting principles, applicable accounting rules and regulations, and/or banking practices, among other examples, a second agent 130(2) may be configured to generate responses for queries that involve tax-related matters and its associated LLM 132 can be trained using query-and-response relationships pertaining to tax laws, regulations, and/or common practices, among other examples, and a third agent 130(3) may be configured to generate responses for queries involving product or service questions (such as a help line or link for an online mortgage service) and its associated with LLM 133 can be trained using query-and-response relationships pertaining to user questions about how to perform certain operations or tasks associated with products or services provided by the online resource 120 (such as how to run a report, how to generate a graph indicative of certain data or trends, or how to access an account or service provided by the online resource 120). In some instances, training data used to train the LLMs 131-133 may include only query-and-response relationships that resulted in a positive or successful user experience (e.g., having a user rating that exceeds a threshold). In some aspects, the training data can include query-and-response relationships determined for one or more previous portions of the conversation between the user and the automated assistant 126.

In accordance with various aspects of the present disclosure, each agent of the agents 130 may include a generative AI model, such as an LLM, configured and trained to perform functions in response to user queries (or sub-queries) that involve different contexts. In some implementations, each agent 130 can be configured and trained using query-and-response training data associated with a unique context or a unique group of contexts. For example, as described above with respect to the agent data store 124B, a first agent 130(1) may be configured and trained to gather structured data for queries that involve tax-related matters, a second agent 130(2) may be configured and trained to generate documents involving tax-related matters using structured data gathered by the first agent 130, a third agent 130(3) may be configured and trained to gather structured data relating to product or service questions, a fourth agent 130(4) may be configured and trained to perform actions, such as applying settings relating to products or services using the structured data gathered by the third agent 130, and so on. In this way, the agents 130(1)-130(N) can be individually tailored to gather data or perform actions responses for queries having different contexts or different groups of contexts, and the selected agents 130 can be used to perform functions responsive and tailored to the user's query.

The communications network 150 provides communication links between the online resource 120 and the user device 110. The communications network 150 can be any suitable one or more communication networks including, for example, the Internet, a wide area network (WAN), a metropolitan area network (MAN), a wireless local area network (WLAN), a personal area network (PAN) such as Bluetooth®, a portion of the Public Switched Telephone Network (PSTN), a cellular telephone network, a radio access network (RAN) such as a Fifth Generation (5G) New Radio (NR) system, an Ethernet network, a cable network, a satellite network, or any combination thereof. In other implementations, the communications network 150 may provide communication links between the online resource 120 and each of the agents 130(1)-130(N).

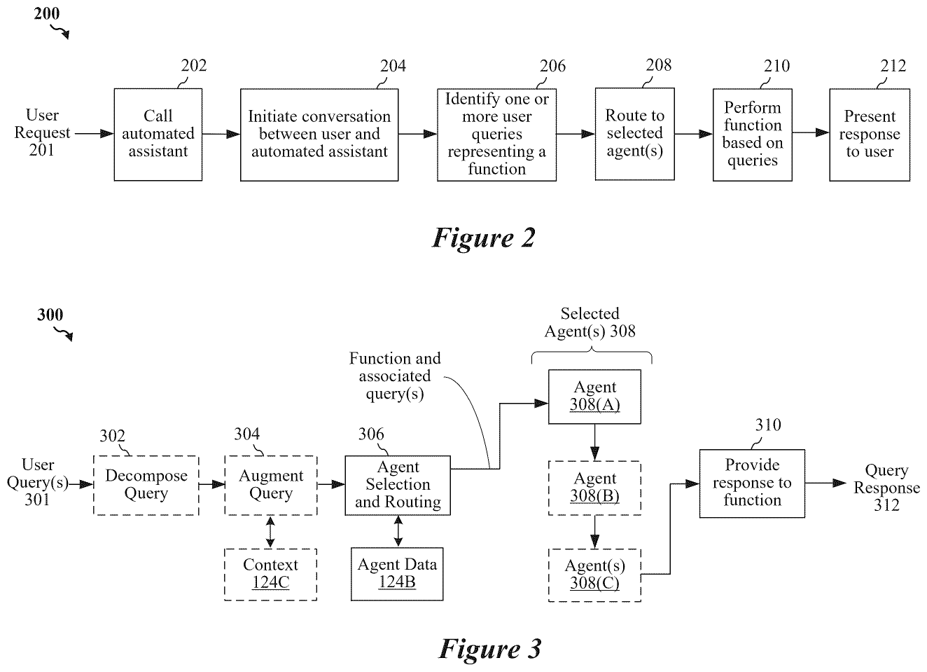

FIG. 2 depicts an example process flow 200 for routing user requests from an automated assistant associated with an online resource, in accordance with some example implementations. For example, the process flow 200 may be performed by the online resource 120 in conjunction with the plurality of agents 130(1)-130(N) described with respect to FIG. 1. The process flow 200 begins with the user sending a request 201 for an automated assistant to the online resource 120 via the user device 110. As discussed, the request 201 may be a spoken word or phrase, a word or phrase entered as text, the user touching an icon on a display screen, the user clicking on a button or link presented on a display screen, and the like. In response to receiving the request 201, the online resource 120 calls, executes, or otherwise invokes the automated assistant 126 described with respect to FIG. 1 (202). When invoked, the automated assistant 126 initiates a conversation with the user over the communications network 150 (204). The conversation may be conducted over a voice call, an online chat session, or an electronic messaging feature, among other examples. In some aspects, the automated assistant 126 is presented to the user as a dialogue box on a display screen associated with the user device 110. In other aspects, the automated assistant 126 is presented to the user as a participant in a native messaging app or program executing on the user device 110. In some other aspects, the automated assistant 126 is presented to the user as a participant in a voice call with the user.

The online resource 120 identifies one or more queries spoken or input by the user during the conversation, and then determines a function corresponding to the one or more queries (206), and then routes the identified queries to their respective selected agents for performing the function in response to the identified queries (208). As discussed, the online resource 120 may determine one or more agents for performing the function based on the function descriptions stored in the agent data 124B. In some aspects the multiple agents may include an ordered plurality of agents, such as one or more first agents being configured to gather and structure relevant data which is then used by one or more second agents for performing an action based on or using the gathered data, such as filling in a form, generating a document, running a script, and so on. In some aspects, the online resource 120 may determine a context for each of the identified queries and use the determined contexts to select one or more of the agents 130 for performing the function.

In some implementations, the online resource 120 can compare the query and its associated context to the function descriptions and select the function whose description most closely matches the query and context. In various aspects, the online resource 120 may employ a similarity engine to determine a degree of similarity between the queries (and their context) and each of the function descriptions, and then select the function associated with the highest similarity score. The context may include topics, one or more previous portions of the conversation between the user and automated assistant, a browsing history of the user within a user assistance page or web site associated with the online resource, a type of application through which the user sends the request to the online resource, or any combination thereof.

In some aspects, when multiple agents are required to perform the selected function, the queries may be routed to a first agent of the multiple agents. For example, when a function includes gathering information and then using the gathered information for performing another action, agents configured to gather this information may receive the queries first. Then after gathering such information, the gathered information may be provided to selected agents configured to use that information for other portions of the function, such as generating a document, processing the information, performing another task based on the gathered information, and so on.

The selected agents 130 then operate to perform the function to generate a response to the identified queries (210). In some aspects, as discussed above, multiple agents may perform the function. Thereafter, a document, link, or a message representing a result of performing the function is returned from at least one of the selected agents 130 to the online resource 120, and the online resource 120 presents the document, link, or message to the user via the user device 110 (212). In some aspects, the automated assistant 126 presents the document, link, or message in a dialogue box on a display screen associated with the user device 110. In other aspects, the automated assistant 126 presents the document, link, or message to the user as a participant in a native messaging app or program executing on the user device 110. In some other aspects, the automated assistant 126 notifies the user of the document, link, or message in a voice call with the user, and presents the document, link, or message to the user in an email, text message, or the like (for example, the user's contact information and preferred mode of contact may be stored in the user data 124A of the online resource 120).

FIG. 3 depicts an example process flow 300 for performing a function in response to complex queries from a user, in accordance with some implementations. For example, the process flow 300 may be performed by the online resource 120 or another suitable device or system capable of receiving queries from users. With respect to FIG. 3, a user query 301 may be received from a user device, such as the user device 110. In some implementations, the user query 301 may be received via the network 150 or another suitable wired or wireless interface to the user device 110.

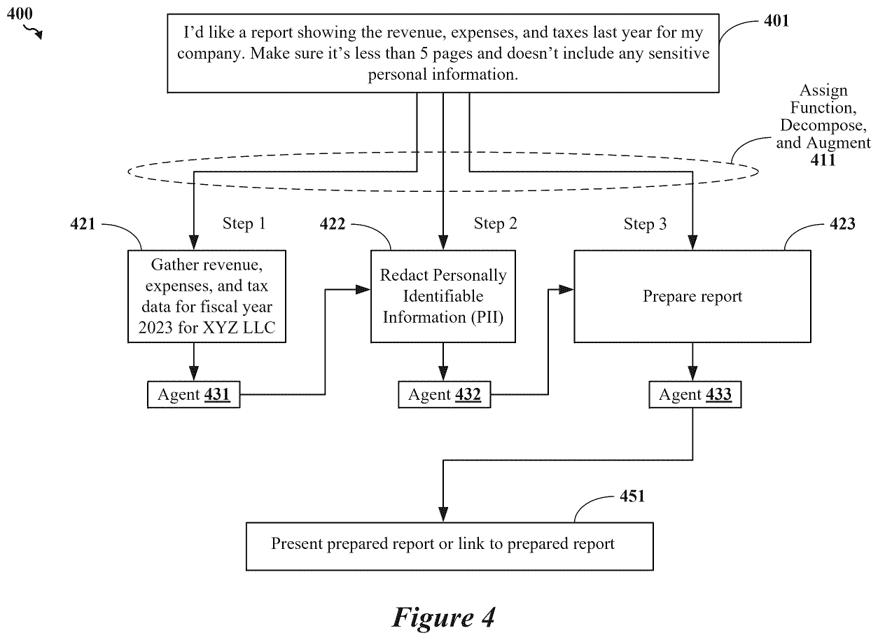

In some aspects, the received user query 301 may include multiple questions or prompts corresponding to a single function, and so the user query 301 may optionally be decomposed (302), so that each of these constituent questions or prompts (“subqueries”) may be routed to an appropriate agent for performing a part of the single function. For example, the automated agent 126 may perform the query decomposition using one or more of the LLMs 125. The decomposed subqueries may also optionally be augmented (304). For example, such augmentation may be based on context, such as the context 124C, and may include contextual information associated with a respective subquery. Such contextual information may include portions of previous queries or comments received from the user. The contextual information may also include information about the user submitting the user query 301, such as one or more usernames, account information, user demographic information, which application or which functionality within that application the user was accessing when submitting the user query 301, and so on. The query augmentation may add to or rephrase a subquery based on such context. An example of such query augmentation is shown and described with respect to FIG. 4.

Appropriate agents may then be selected for each of the augmented subqueries and each of the optionally augmented subqueries routed to their selected agent (306). For example, a function may be assigned to the query or sub-queries based on a similarity between the query or sub-queries and corresponding function description data, and assigning a function to the query or sub-queries may include assigning one or more agents for performing the steps of the assigned function. For example, the function description data may include one or more agents configured to perform the steps of the function.

More particularly, the automated agent 126 may use one or more of the LLMs 125 to assign each augmented subquery to a respective agent based on a comparison of the augmented subqueries to the function description data. In some aspects, the available functions may be limited based on the context of the query, such as an application or geographic region associated with the user query 301. For example, a different set of functions may be available for user queries which are associated with an accounting application as compared to user queries associated with an email application, or a social media application.

Note that while FIG. 3 shows agent selection and routing 306 occurring after decomposition 302 and augmentation 304, that in some aspects a function may be selected for the query 301 (based on a similarity between the query 301 and the function descriptions of the agent data 124B) prior to query decomposition and augmentation. More particularly, in some aspects, the user query 301 may be compared to the function descriptions of the agent data 124B prior to decomposition and augmentation, while in some other aspects, the query 301 may be decomposed (302) and augmented (304) before the decomposed and augmented sub-queries are compared to the function descriptions.

The augmented subqueries may be routed to the selected agents. For example, the agent data 124B may include routing data for each agent, and the augmented subqueries may be routed to the appropriate agent via the routing data associated with the selected agents. With respect to FIG. 3, the augmented subqueries are routed to agents 308(A), 308(B), and 308(C) (the “selected agents 308”). Note that not all functions may require the use of multiple agents to perform, and so agents 308(B) and 308(C) are shown as optional.

As discussed below with respect to FIG. 4, a query may include multiple parts, such as the gathering of multiple types of data for performing one or more actions, or for inclusion in a single document, form, email, and so on. In such an example, the selected agents 308 may include an ordered plurality of agents, such that the output from one agent is used by another agent. For example, a first agent 308(A) may gather and structure information for use by another agent. Similarly, a second agent 308(B) may receive the structured information gathered by the first agent 308(A). For example, a user query 301 may request the generation of a report based on a user's personal or financial information, but that sensitive personal information be redacted in that report. For performing such a function, a second agent 308(B) may receive structured information representing the user's financial information and redact sensitive personal information such as social security numbers, addresses, and so on from the structured information. Subsequently, a third agent 308(C) may generate the requested report using the gathered and redacted information. Note that while FIG. 3 shows agent 308(A) providing an intermediate response to Agent 308(B), which provides an intermediate response to Agent 308(C), that in some aspects, each of these agents may instead provide a response to the online resource 120, which may then send the intermediate response to the next agent in the ordered plurality of agents.

The selected agents 308 perform the function from the user query 301 and provide a response representing a result of performing the function to the online resource 120. Such a response may be at least one of a document, a message, or a link representing the result of performing the function. For example, a function may include generating a document and the response may include the generated document or a link to the generated document. In some other examples, the function may include performing an action, such as running a script based on gathered information (such as using gathered parameters or configurations), and the response may include a message such as a log file documenting the execution of the script. In some aspects, the response may be provided to the automated assistant 126 of the online resource 120. The response can be transmitted to the user device 110 over the communications network 150 and presented to the user via the user interface 112 of the user device 110. The automated assistant 126 can present the response to the user as part of the conversation between the user and the automated assistant 126. In some instances, the automated assistant 126 can present the answer to the user in a suitable dialogue box displayed on the user interface 112. In other instances, the automated assistant 126 can present the answer to a communication, such as an email or text message, sent to the user, such as sent to the user's email address or other contact information included in the user data 124A of the online resource 120.

FIG. 4 shows an example process flow 400 through which an example query is decomposed, augmented, and answered, according to some implementations. In various aspects, the process flow 400 may be performed by the online resource 120 of FIG. 1 and/or may be based on the example process flow 300 described with respect to FIG. 3. In some aspects, the queries may be received from the user device 110 via the network 150 or another suitable wired or wireless interface.

A query 401 may be received by the online resource 120. As shown in FIG. 4, the query 401 is a request for the performance of a function. More specifically the query 401 includes a request for the generation of a report including information about the user's company, relating to the user's company revenue, expenses, and taxes, but redacting sensitive personal information.

As described above with respect to the process flow 300 of FIG. 3, complicated queries, such as the query 401, may be decomposed into simpler sub-queries, and augmented using context. Similarly, with respect to the query answering flow 400, the query 401 may be decomposed and augmented (411) into several sub-queries, namely a first sub-query 421, a second sub-query 422, and a third sub-query 423. Note that the specific decomposition shown in FIG. 4 is only one example of how a complicated query may be decomposed using the example implementations. For example, sub-query 423 includes both a request for information and a request for assistance with software, and in some aspects, this sub-query may instead be decomposed into two sub-queries, a first sub-query requesting employee headcount for their company, and a second sub-query requesting assistance with adding employees to a company account.

In some aspects, the function may be assigned prior to decomposition and augmentation. In other aspects, the query 401 may first be decomposed and augmented, and then one or more of the decomposed and augmented sub-queries may be assigned to a function based on a comparison between the sub-queries and the function descriptions.

The function represented by the query 401 may be decomposed and augmented into several steps, namely a first step 421, a second step 422, and a third step 423. Note that the specific decomposition shown in FIG. 4 is only one example of how a complicated query may be decomposed using the example implementations. For example, the query 401 includes both requests for gathering information and also for redacting portions of the gathered information. In FIG. 4 this is shown as two different steps, step 421 and step 422. However, in some other implementations a single agent may perform both the information gathering and the redaction of personal information. In some other aspects, a first agent may be configured to gather data about revenue and expenses while a second agent may be configured to gather the tax-related information. As discussed above, in addition to decomposing the query 401 into multiple sub-queries or steps, each sub-query may be augmented based on the user's context. For example, while the query 401 refers to “my company” and to “last year,” the step 421 augments that query with the actual name of the user's company (XYZ LLC) and the specific year (fiscal year 2022). Similarly, the sub-queries may be augmented based on the context of the query's submission, such as the application through which the user submitted the query 401. For example, the user may submit the query 401 through the QuickBooks application, and this context may be used to augment the sub-query 423 to request that the revenue, expense, and/or tax information be retrieved from XYZ LLC's account in QuickBooks specifically based on this context. While not shown in FIG. 4 for simplicity, the sub-queries 421, 422, and 423 may also include additional details, such as one or more identifying details for XYZ LLC, one or more portions of the user's conversation history relevant to a particular sub-query, and so on.

The decomposed and augmented sub-queries may be routed to various selected agents. As discussed above with respect to FIG. 3, each sub-query may be routed to a corresponding agent based at least in part on the context for the query. In some instances, the context may include the type of software application through which the user submitted the query to the online resource 120. For example, if the user submitted the query via an accounting application or accounting web portal, then the corresponding sub-queries may be routed to agents configured to generate responses to accounting related queries. For another example, if the user submitted the query via a tax software or tax preparation web portal, then the corresponding sub-queriesmay be routed to agents configured to generate responses to tax related queries. In other instances, the context may include the type of software application through which the user submitted the query to the online resource 120. For another example, if the user submitted the query via an accounting application or accounting web portal, then the corresponding sub-queries may be routed to agents configured to generate responses to accounting related queries.

In various aspects, the selection of agents for a respective sub-query may also be based on agent descriptions in view of the content or context of the sub-query. For example, the automated assistant 126 may use one or more of the LLMs 125 to compare the sub-query with the agent descriptions for the available agents to determine the most suitable agent to handle each of the sub-queries. In the example of FIG. 4, a first agent 431 is selected for the first sub-query 421, a second agent 432 is selected for the second sub-query 422, and a third agent 431 is selected for the third sub-query 423. After selecting agents 431-433 for generating responses to respective sub-queries 421-423, the automated assistant 126 may route the sub-queries 421-423 to their respective agents 431-433.

Because performing the function represented by the query 401 may involve an ordered series of steps, the selected agents may have at least a partial order, and maybe an ordered plurality of agents. In the example of FIG. 4, the financial information (revenue, expenses, and tax information) must be gathered before personally identifiable information (PII) in that gathered information may be redacted. Similarly, information must be gathered before it may be incorporated into a report. Thus, the agent 431 may be considered first in the ordered plurality of agents, the agent 432 may be second, while the agent 433 may be the final agent in the plurality of agents for performing the function represented by the query 401.

Note that while FIG. 4 shows the first agent 431 providing information to the second agent 432, which then in turn provides information to the third agent 433, one or more agents in an ordered plurality of agents may return a result, such as gathered information, to the online resource 120. The online resource 120 may then send the result to a subsequent agent in the plurality of agents.

The selected agents 431-433 perform their assigned steps, such as gathering or processing information as directed, performing one or more actions based on the gathered information, and so on, one or more of the selected agents 431-433 forwards the generated response to the online resource 120 for provision to the user. For example, one or more of the selected agents 431-433 may return a document, a message, or a link representing the result of completing the function of the query 401 to the automated assistant 126 providing to the user.

After the selected agents perform the function and return the response, the returned response may be provided (451) to the user. For example, the response 451 may include the prepared report or a link to the prepared report which is provided to the user device 110 via the network 150 or another suitable wired or wireless interface. In the example of FIG. 4, the response 451 responds to the user's request for a redacted report of the user's company's revenue and expenses, and taxes in the last year. In some aspects, the response 451 may include one or more links to information the user has requested. For example, rather than providing the requested report directly, the response 451 may include a link to the generated report, alongside a short message. Such a message may include a network or other address (such as a hyperlink) where the report may be found, and may also include a short phrase, such as “the requested report may be accessed by selecting this link,” or another suitable sentence. In some other aspects, the contents of the generated report may be directly included in the response 451, such as by including the entire text of the report, providing a selectable thumbnail or image of the report.

FIG. 5 shows an illustrative flowchart 500 depicting an example operation for assisting a user of an online resource, according to some implementations. In some implementations, the example operation 500 is performed by the online resource 120 described with respect to FIG. 1. For example, at 502, the online resource 120 receives, from the user over a communications network coupled to the computing system, a query including a plurality of sub-queries. At 504, the online resource 120 determines a function corresponding to each of the sub-queries. At 506, the online resource 120 selects, for each function, one agent of a plurality of agents based on a context for the corresponding sub-query. At 508, the online resource 120 sends each sub-query to a corresponding selected agent. At 510, the online resource 120 receives, from each of the selected agents, at least one of a document, a message, or a link representing a result of performing the corresponding function. In various aspects, each of the plurality of agents is associated with a corresponding large language model (LLM) trained using query-and-response training data associated with a unique context or a unique group of contexts.

In some instances, the function includes gathering information and generating the document based at least in part on the gathered information. The document may include at least one of a report generated using the gathered information, a form including one or more fields completed based at least in part on the gathered information, or an email generated based on the gathered information.

Selecting the agent for a respective function may include selecting an ordered plurality of agents for performing the respective function. In some instances, the ordered plurality of agents includes a first agent configured to gather information and a second agent configured to perform one or more actions based at least in part on the information gathered by the first agent. In some aspects, the first agent is configured to return the gathered information via the communications network to the computing system, and the method further comprises sending at least a portion of the gathered information via the communications network to the second agent.

The query may be received during a conversation between the user and an automated assistant associated with the online resource, and the context for each sub-query is based at least in part on one or more previous portions of the conversation. In some aspects, the context for each sub-query further includes a browsing history of the user within a user assistance page or web site associated with the online resource. In other aspects, the context for each sub-query is further based on a type of application through which the user accesses the online resource.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits, and algorithm processes described in connection with the implementations disclosed herein may be implemented as electronic hardware, computer software, or combinations of both. The interchangeability of hardware and software has been described, in terms of functionality, and illustrated in the various illustrative components, blocks, modules, circuits and processes described above. Whether such functionality is implemented in hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method for assisting a user of an online resource, the method performed by one or more processors of a computing system associated with the online resource and comprising:
receiving, from the user over a communications network coupled to the computing system, a query including a plurality of sub-queries;
determining a function corresponding to each of the sub-queries;
selecting, for each function, one agent of a plurality of agents based on a context for the corresponding sub-query;
sending each sub-query to a corresponding selected agent; and
receiving, from each of the selected agents, at least one of a document, a message, or a link representing a result of performing the corresponding function.

2. The method of claim 1, wherein each of the plurality of agents is associated with a corresponding large language model (LLM) trained using query-and-response training data associated with a unique context or a unique group of contexts.

3. The method of claim 1, wherein the function comprises gathering information and generating the document based at least in part on the gathered information.

4. The method of claim 3, wherein the document comprises at least one of a report generated using the gathered information, a form including one or more fields completed based on the gathered information, or an email generated based on the gathered information.

5. The method of claim 1, wherein selecting the agent for a respective function further comprises selecting an ordered plurality of agents for performing the respective function.

6. The method of claim 5, wherein the ordered plurality of agents comprise a first agent configured to gather information and a second agent configured to perform one or more actions based at least in part on the information gathered by the first agent.

7. The method of claim 6, wherein the first agent is configured to return the gathered information via the communications network to the computing system, and the method further comprises sending at least a portion of the gathered information via the communications network to the second agent.

8. The method of claim 1, wherein the query is received during a conversation between the user and an automated assistant associated with the online resource, and the context for each sub-query is based at least in part on one or more previous portions of the conversation.

9. The method of claim 8, wherein the context for each sub-query further includes a browsing history of the user within a user assistance page or web site associated with the online resource.

10. The method of claim 8, wherein the context for each sub-query is further based on a type of application through which the user accesses the online resource.

11. A computing system associated with an online resource, the computing system comprising:
one or more processors; and
a memory communicatively coupled with the one or more processors and storing instructions that, when executed by the one or more processors, causes the computing system to:
receive, from the user over a communications network coupled to the computing system, a query including a plurality of sub-queries;
determine a function corresponding to each of the sub-queries;
select, for each function, one agent of a plurality of agents based on a context for the corresponding sub-query;
send each sub-query to a corresponding selected agent; and
receive, from each of the selected agents, at least one of a document, a message, or a link representing a result of performing the corresponding function.

12. The computing system of claim 11, wherein each of the plurality of agents is associated with a corresponding large language model (LLM) trained using query-and-response training data associated with a unique context or a unique group of contexts.

13. The computing system of claim 11, wherein the function comprises gathering information and generating the document based at least in part on the gathered information.

14. The computing system of claim 13, wherein the document comprises at least one of a report generated using the gathered information, a form including one or more fields completed based on the gathered information, or an email generated based on the gathered information.

15. The computing system of claim 11, wherein execution of the instructions to select the agent for a respective function further causes the computing system to select an ordered plurality of agents for performing the respective function.

16. The computing system of claim 15, wherein the ordered plurality of agents comprise a first agent configured to gather information and a second agent configured to perform one or more actions based at least in part on the information gathered by the first agent.

17. The computing system of claim 16, wherein the first agent is configured to return the gathered information via the communications network to the computing system, and execution of the instructions further causes the computing system to send at least a portion of the gathered information via the communications network to the second agent.

18. The computing system of claim 11, wherein the query is received during a conversation between the user and an automated assistant associated with the online resource, and the context for each sub-query is based at least in part on one or more previous portions of the conversation.

19. The computing system of claim 18, wherein the context for each sub-query further includes a browsing history of the user within a user assistance page or web site associated with the online resource.

20. The computing system of claim 18, wherein the context for each sub-query is further based on a type of application through which the user accesses the online resource.
